(19) United States
(12) Patent Application Publication
(10) Pub. No.: US 2008/0277975 A1
(43) Pub. Date: Nov. 13, 2008

(54) Locking Mechanism for a Folding Top Compartment Cover of a Convertible

(75) Inventors: Peter Biecker, Oberhaching (DE); Stefan Miklosi, Munich (DE)

Correspondence Address: MARSHALL, GERSTEIN & BORUN LLP, 233 S. WACKER DRIVE, SUITE 6300, SEARS TOWER, CHICAGO, IL, 60606, US

(73) Assignee: WEBASTO AG, Stockdorf (DE)

(21) Appl. No.: 12/091,716

(22) PCT Filed: Oct. 23, 2006
(86) PCT No.: PCT/DE2006/001906

§ 371 Date: Apr. 25, 2008

(30) Foreign Application Priority Data
Oct. 28, 2005 (DE) 10 2005 052 063.4

(51) Int. Cl. B60J 7/185

(52) U.S. Cl. 296/224

(57) ABSTRACT

A locking mechanism for fastening a support device of a folding top compartment cover of a convertible, said support device being movably mounted on the body by a drive unit. A first lock unit that is mounted on the body is provided for removably locking the support device to the body while a second lock unit that is mounted on the support device is provided for removably locking the folding top compartment cover, which is movably mounted on the support device, to the support device. In addition, an actuating device is provided for actuating the two lock units.

The invention relates to a locking mechanism for securing a support device of a folding top compartment cover of a convertible, which support device is mounted movably on the vehicle body by means of a driving device.

DE 101 07 079 A1 has disclosed a convertible which has, in its rear region, a support device, to the front side of which a folding top compartment cover is attached fixedly and on the rear side of which a tailgate is mounted movably by means of a bearing device. The support device can be adjusted between a closed position and a rearwardly pivoted open position by means of a four-bar linkage device on the vehicle body and can be locked to the vehicle body in its closed position by means of a lock device. The lock device contains on both sides in each case two locks which are spaced apart from one another in the longitudinal direction, are arranged on the support device and are connected to a common drive arranged on the support device. According to an alternative design, the front lock is arranged on the vehicle body and the rear lock is arranged on the support device and each lock is assigned its own drive. The tailgate can be locked by means of a tailgate lock which is arranged in the region of the bearing device of the tailgate.

DE 44 45 944 C1 has disclosed a vehicle with a convertible folding top which can be put away in a folding top compartment. A folding top compartment cover which simultaneously forms a tailgate or a trunk cover is mounted movably by means of an articulated device on an auxiliary frame which is supported movably via a pivot spindle, which is mounted on the vehicle, in a lower end region of the vehicle. The folding top compartment cover can be pivoted to the rear about the pivot spindle, which is mounted on the vehicle, together with the auxiliary frame such that an opening is free for the folding top to be put away. In its function as a trunk flap, the folding top compartment cover is pivotable about a front pivot spindle.

The invention is based on the object of improving a locking mechanism mentioned at the beginning in respect of improved functionality and simplified actuation.

The object is achieved according to the invention with a locking mechanism mentioned at the beginning by a first lock unit, which is mounted on the vehicle body, for releasably locking the support device to the vehicle body, a second lock unit, which is mounted on the support device, for releasably locking the folding top compartment cover, which is mounted movably on the support device, to the support device, and an actuating device for actuating the two lock units. The actuation of the two lock units provided for the support device and for the folding top compartment cover can therefore be undertaken in a cost-effective and operationally reliable manner by means of a single or common drive.

The support device with the folding top compartment cover, which can also form a tailgate or a trunk cover, is provided for convertibles with a convertible hard top roof or soft top roof, but may also be used in other vehicles.

Advantageous refinements of the invention are indicated in the subclaims.

A design is particularly preferred, according to which the actuating device is connected to the driving device which adjusts the support device. On account of the actuation being derived from the driving device, an independent drive or driving motor is therefore not required.

The two lock units are expediently arranged adjacent to each other and therefore can be actuated by the common actuating device without great complexity.

For the common actuation, it can be provided that the first lock unit and the second lock unit are connected to each other in a releasable coupling engagement when the actuation takes place. By means of the releasable coupling engagement, the two lock units or the components supporting the lock units can be moved away from each other during the course of putting away the roof when they execute the required movements.

A latching hook of the first lock unit and a lock hook of the second lock unit can expediently be coupled to each other via engagement elements in order to realize the common actuation. In particular, an actuating pin and a slotted guide which receives the actuating pin form the engagement elements, but different engagement elements may also be used. The latching hook and the lock hook can be mounted pivotably or else displaceably.

The locking mechanism is preferably formed in such a manner that, in a closed position, the support device is kept locked to the vehicle body by means of the first lock unit, with the second lock unit having released the folding top compartment cover from the support device.

The actuating device, which is formed in particular as a Bowden cable, is preferably connected to a latching hook of the first lock unit. The first lock unit or the latching hook thereof can then be coupled to the second lock unit or the lock hook thereof via the coupling device or the engagement elements.

A lock hook or the lock hook of the second lock unit is preferably prestressed by means of a prestressing device into its closed position in which it keeps the folding top compartment cover or a bearing part of the folding top compartment cover locked to the support device. The lock hook therefore maintains this closed position even when it is decoupled from the first lock unit.

The folding top compartment cover is preferably attached by means of a mount to a bracket which is mounted movably on the support device by means of a link device.

An expedient design makes provision for the driving device to be guided displaceably at its end coupled to the actuating device along a guide and to be lockable by means of a retaining device in an end position in which the first lock unit is unlocked. This obtains a defined sequence of movement for the pivoting of the support device and of the folding top compartment cover, with the weight of said components, which reacts on the driving device, being taken into consideration. The retaining device can preferably be actuated by a lever, which is movable by the driving device, for driving the support device.

A locking mechanism according to the invention is explained in more detail below using an exemplary embodiment and with reference to the drawing, in which:

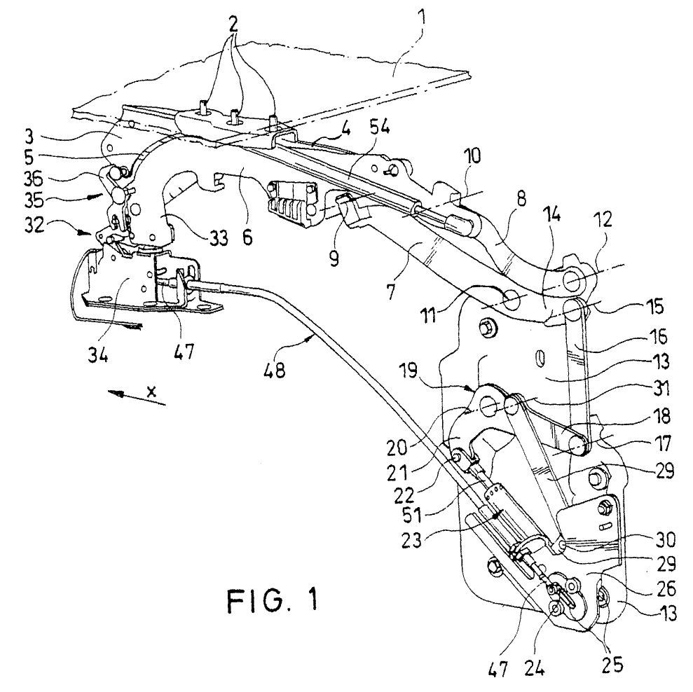

FIG. 1 shows, in a perspective top view, a right support device of a folding top compartment cover of a convertible, which support device is arranged in a closed position and is locked to the vehicle body by means of a locking mechanism;

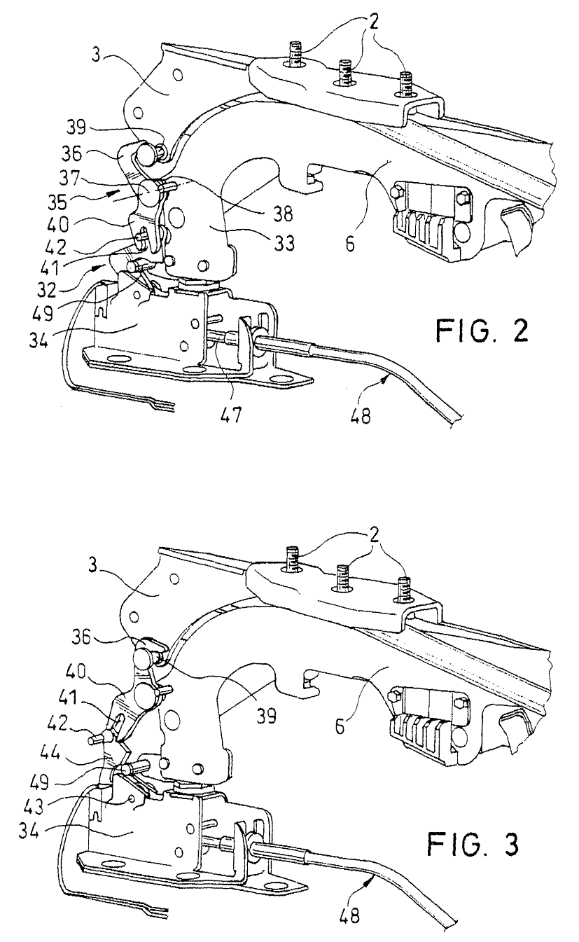

FIG. 2 shows, in a perspective top view and in an enlarged partial illustration, the support device of FIG. 1;

FIG. 3 shows, in a view according to FIG. 2, the support device released from the vehicle body;

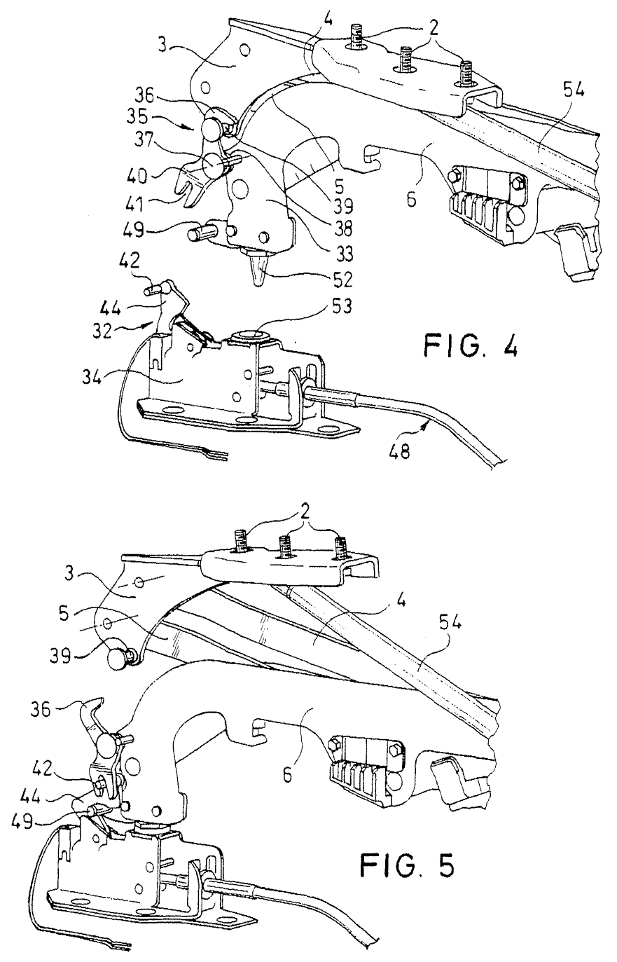

FIG. 4 shows, in a view according to FIG. 2, the support device which is released from the vehicle body and raised;

FIG. 5 shows, in a view according to FIG. 2, the support device, which is locked to the vehicle body, with the released and pivoted-up folding top compartment cover;

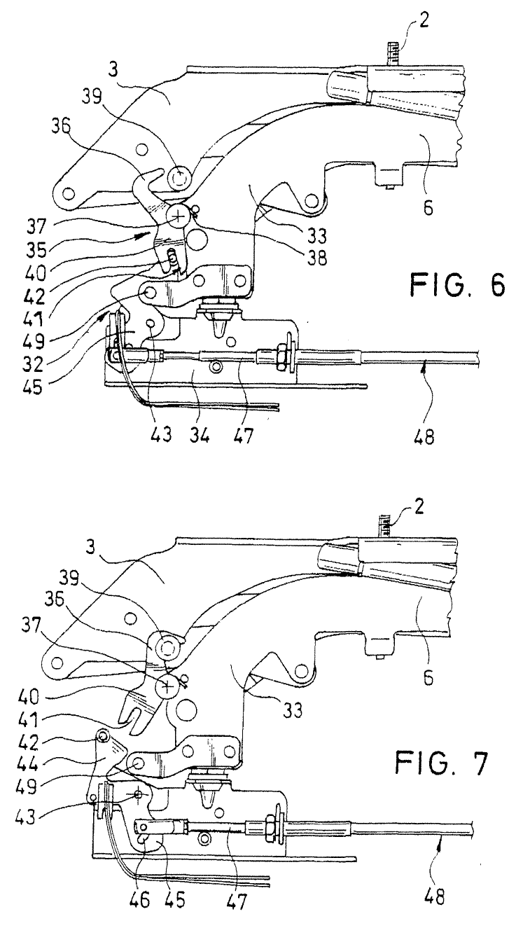

FIG. 6 shows, in a side view, the front section of the support device locked to the vehicle body, and the released mount of the folding top compartment cover;

FIG. 7 shows, in a side view according to FIG. 6, the front section of the support device released from the vehicle body, and the locked mount of the folding top compartment cover;

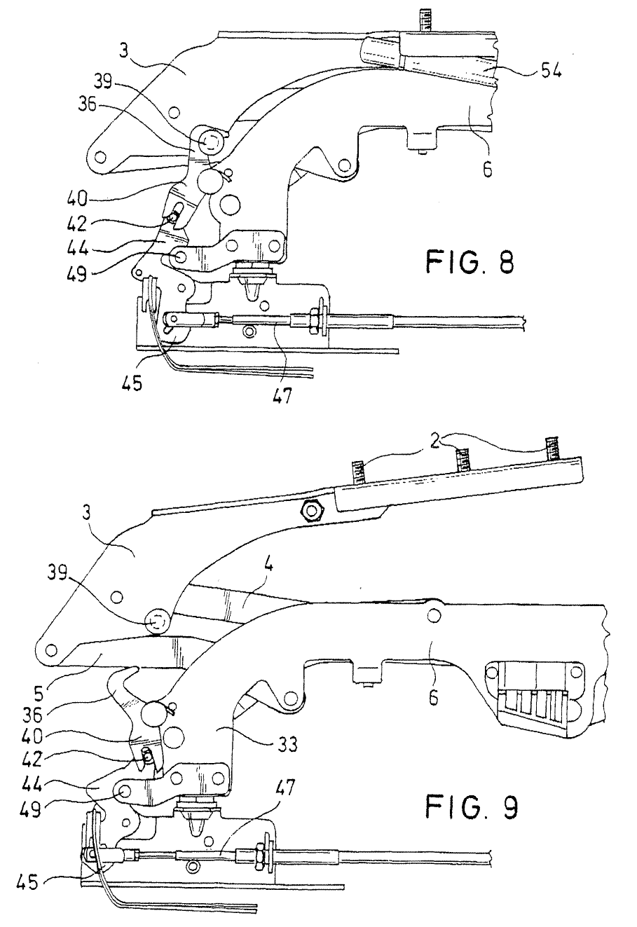

FIG. 8 shows, in a side view according to FIG. 6, the locking mechanism in a switching-over position;

FIG. 9 shows, in a side view according to FIG. 6, the locking mechanism in a latching position with the support device with the folding top compartment cover open;

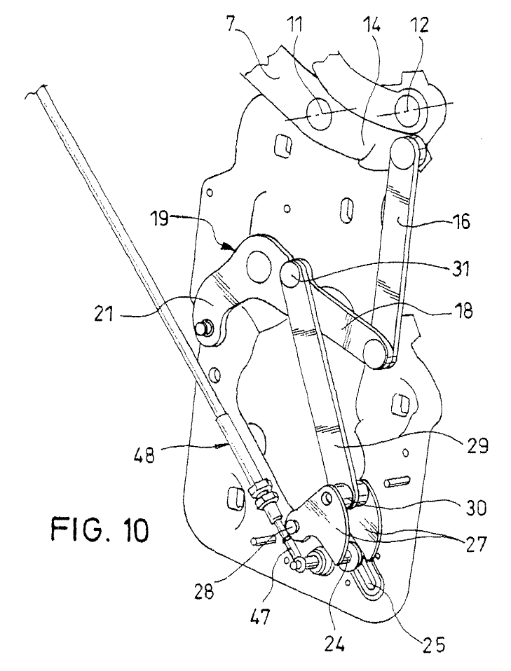

FIG. 10 shows, in a perspective top view and in an enlarged partial illustration, the driving device of the support device and of the locking mechanism in a position according to FIG. 1;

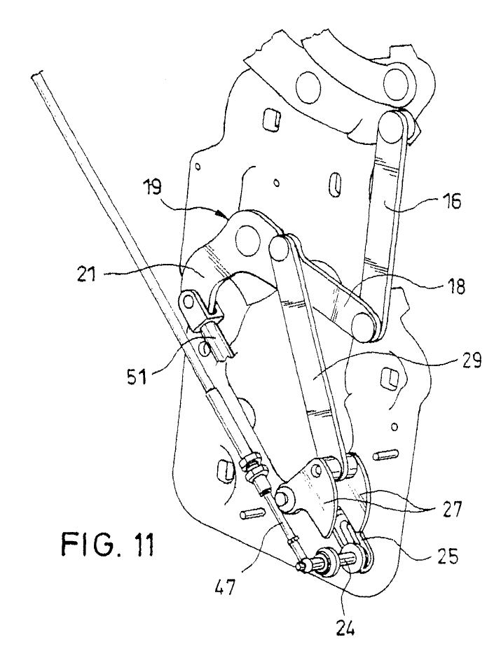

FIG. 11 shows, in a perspective top view and in an enlarged partial illustration, the driving device of the support device and of the locking mechanism in a position according to FIGS. 3 and 7; and

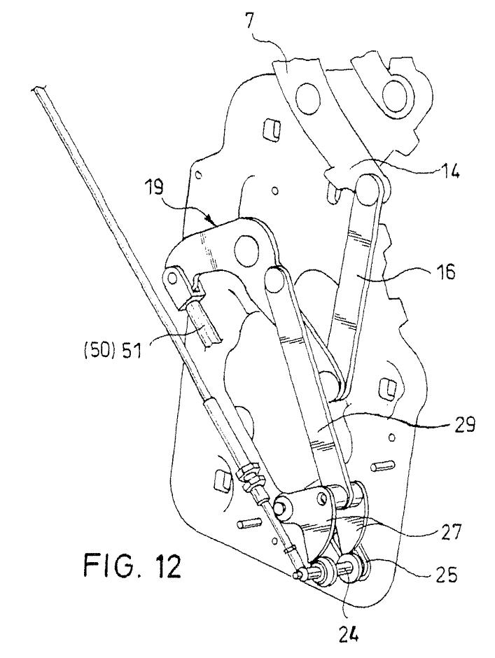

FIG. 12 shows, in a perspective top view and in an enlarged partial illustration, the driving device in a latching position with the support device pivoted up.

A convertible has a convertible top compartment cover 1 (the folding top compartment cover 1 is partially and schematically illustrated only in FIG. 1) which is provided for covering a rear folding top storage space and is raised at its front edge (the arrow denoted by x in FIG. 1 points forward in the longitudinal direction of the vehicle) in order to release a passage opening for the folding roof or folding top which is to be displaced between its closed position and its storage position and which may be a hard top roof or a soft top roof. The folding top compartment cover 1 expediently also serves as a trunk cover by being pivoted upward at its rear edge relative to the vehicle body out of its closed position (FIG. 1) and therefore opening up a loading opening of the trunk. DE 44 45 944 C1 discloses a comparable folding top compartment cover which is supported on the vehicle body via an auxiliary frame and, according to the exemplary embodiment, is mounted pivotably on the vehicle rear about a pivot spindle mounted on the vehicle body.

The folding top compartment cover 1 is fastened on both sides by means of a respective mount, which contains, for example, a plurality of screw bolts 2, to a bracket 3 which, in turn, is mounted pivotably via a four-bar linkage mechanism, which is formed by two links 4 and 5, on a support device which is formed, for example, by a frame 6 which supports the bracket 3 or the four-bar linkage mechanism 4, 5. The description is undertaken with reference to the right side of the support device of the folding top compartment cover, which support device is constructed essentially symmetrically with respect to the longitudinal axis of the vehicle, together with the respective driving device and locking mechanism.

The frames 6 on the left and right sides can be connected fixedly to each other, for example by means of a cross bar or the like, in order to increase the stability of the support device.

The support device or the frame 6 of the folding top compartment cover 1 is mounted pivotably on both sides of the vehicle body by means of a respective main link 7 and auxiliary link 8 which form a four-bar linkage mechanism with the joints 9 and 10 on the frame 6 and the joints 11 and 12 on a bearing plate 13 mounted on the vehicle body.

The main link 7 has an extension 14 which extends beyond the joint 11 forming a pivot axis or bearing axis and to the end side of which is coupled, in a joint 15, a connecting rod 16 which is coupled at the other end in a joint 17 to an arm 18 of a two-armed pivot lever 19 which is mounted pivotably about a pivot axis 20 on the bearing plate 13. A driving unit which is formed, for example, by a hydraulic piston/cylinder unit 23 engages on the second arm 21 of the two-armed pivot lever 19 in a coupling point 22.

The piston/cylinder unit 23 is mounted displaceably at the other end via a bearing pin 24 at two elongated hole guides 25 which are arranged in the bearing plate 13 or in a supporting plate 26 attached parallel thereto. A double rotary latch 27 (see FIGS. 10 to 12) is mounted pivotably about an axis 28 between the bearing plate 13 and the supporting plate 26. A control link 29 is coupled to the rotary latch 27 in a joint 30 and to the arm 18 of the pivot lever 19 in a joint 31 and, as a function of the position of the pivot lever 19, pivots the rotary latch 27 into a retaining position on the bearing pin 24 (FIG. 12), in which the latter is held in a lower end position on the elongated hole guides 25, and into a release position (FIGS. 10 and 11), in which the bearing pin 24 is displaceable along the elongated hole guides 25.

A latching device for the folding top compartment cover 1 contains a first lock unit 32 (also see FIGS. 6 to 9) for releasably securing the front end 33 of the frame 6, which front end extends downward, to a bearing unit 34 which is mounted on the vehicle body, and a second lock unit 35 for releasably securing the folding top compartment cover 1 or the bracket 3 to the front end 33 of the frame 6.

The second lock unit 35 contains a lock hook 36 which is mounted pivotably about a transverse axis 37 at the front end 33 of the frame 6 and is prestressed by means of a torsion spring 38 into a closed position (FIGS. 3 and 4 and 7 and 8) in which it engages around a stud 39 which is attached to the bracket 3 of the mounting of the folding top compartment cover 1. The lock hook 36 contains an actuating arm 40, which extends in a manner lying opposite the pivot axis 37, with a slotted guide 41 in which an actuating pin 42 for pivoting the lock hook 36 can be accommodated.

The first lock unit 32 has a latching hook 44 which is mounted pivotably about an axis 43 on the bearing unit 34, which is mounted on the vehicle body, and to which the actuating pin 42 for actuating the second lock unit 35 is attached and to the actuating arm 45 of which, which extends in a manner lying opposite the pivot axis 43, a cable 47 of a Bowden cable 48 is fastened in an elongated hole 46, the other end of which cable is attached to the bearing pin 24 of the piston/cylinder unit 23. The closed latching hook 44 engages behind a latching stud 49 which is attached to the front end 33 of the frame 6 more or less below the pivot axis 37 of the lock hook 36 of the second lock unit 35.

In the closed position of the folding top compartment cover 1 and of the frame 6 that is illustrated in FIGS. 1, 2 and 6, the first lock unit 32 is arranged in its latching position in which the latching hook 44 keeps the latching stud 49 of the frame 6 locked and, via its actuating pin 42, which is in engagement in the slotted guide 41 of the lock hook 36, keeps the lock hook 36 pivoted in its open position counter to the force of the torsion spring 38 such that the bracket 3 is movable and the folding top compartment cover 1 can be pivoted open manually at its rear edge in the sense of a trunk flap, with the four-bar linkage mechanism with the links 4 and 5 being pivoted (see FIG. 5) and, in the process, the bracket 3 being raised.

If the roof is to be opened and put away in the folding top compartment, the folding top compartment cover 1 is raised beforehand, thus exposing the path of movement for putting away the roof (and also for extending it when the roof is closed). For this purpose, the piston/cylinder unit 23 is actuated and, during its initial expansion movement out of the position illustrated in FIG. 1 (the piston/cylinder unit 23 is not shown in FIGS. 10 to 12), first of all its lower end and therefore the bearing pin 24 are moved on the elongated hole guide 25 into the lower stop position (from FIGS. 10 to 11). In the process, the first lock unit 32 is actuated via the cable 47 of the Bowden cable 48, which cable 47 is moved at the same time, the actuating arm 45 and latching hook 44 of which lock unit are pivoted into the open position (movement from FIG. 6 via the intermediate position of FIG. 8 to FIG. 7). The initial expansion movement of the piston/cylinder unit 23 inevitably takes place in this manner by shifting of the housing 50 while the piston rod 51 and the pivot lever 19 are at a standstill, since the weight of the folding top compartment cover 1 and of the frame 6 via the connecting rod 16 acts as a counterforce on the pivot lever 19.

When the first lock unit 32 is released, the actuating pin 42 of the latching hook 44 pivots the lock hook 36 of the second lock unit 35 into its closed position in which it keeps the stud 39 of the bracket 3 locked and at the same time is held by the force of the torsion spring 38 (FIG. 3). The actuating pin 42 is now in a position in which it is disengaged from the slotted guide 41, and therefore the frame 6, and in particular the front end 33 thereof, can be raised (movement from FIG. 3 to FIG. 4). The lock hook 36 is shaped in such a manner and its pivot axis 37 is arranged with respect to the stud 39 in such a manner that the line of action of the opening force of the folding top compartment cover 1 on the stud 39 runs essentially through the pivot axis 37 of the lock hook 36.

The raising of the frame 6 and therefore of the folding top compartment cover 1 takes place by means of the piston/cylinder unit 23 which continues to be actuated and is now supported at its lower end or by the bearing pin 24 at the lower end of the elongated hole guide 25 and, accordingly, pivots the pivot lever 19 by expansion of the piston rod 51, as a result of which the frame 6 is pivoted into the raised open position via the coupling of the connecting rod 16 to the main link 7 (via the position of FIG. 4 into the position of FIG. 12). When the pivot lever 19 is pivoted into its end position, the rotary latch 27 is pivoted via the control link 29 into its retaining position (see FIG. 12) in which it keeps the bearing pin 24 and therefore the lower end or the housing 50 of the piston/cylinder unit 23 locked in the lower end position. An undesired movement of the whole of the piston/cylinder unit 23 along the elongated hole guide 25 is therefore prevented.

When the frame 6 is raised and the folding top compartment cover 1 is raised by the frame 6, the roof can be moved in a known manner into the folding top compartment or roof storage space and, for closing the roof, can also be moved out of it again.

The closing of the folding top compartment cover 1 or of the frame 6 takes place in an opposite sequence of movement by retraction of the piston rod 51 of the piston/cylinder unit 23 out of the position according to FIG. 12, with the rotary latch 27 first of all remaining in its latching position and keeping the bearing pin 24 and therefore the housing 50 of the piston/cylinder unit 23 in the lower position such that a defined sequence of movement is also ensured during the closing of the roof and of the folding top compartment cover 1 and of the frame 6.

When the frame 6 is moved at its front end 33 into its closed position on the bearing unit 34 and is accommodated by a centering lug 52 in a centering receptacle 53 of the bearing unit 34, the rotary latch 27 has also taken up its open position via the activation of the control link 29, and therefore the further actuation or shortening of the piston/cylinder unit 23 over the final adjustment path leads to the lower end of the housing 50 or the bearing pin 24 moving upward on the elongated hole guide 25 into the opposite end position. In the process, the latching hook 44 of the first lock unit 32 is actuated via the cable 47 of the Bowden cable 48, said latching hook, upon pivoting into its closed position, grasping the latching stud 49 and therefore pulling the support device or the frame 6 downward into a fixed latching connection on the vehicle body.

The Bowden cable 48, as part of the actuating device, can be adapted in a largely flexible manner to the structural conditions in the rear region of the vehicle body. However, other means, such as, for example, linkages for transmitted the actuating movement, can also be used.

The folding top compartment cover 1 can be supported in relation to the frame 6 by a respective gas-filled compression spring 54, and therefore it is relieved of weight during manual pivoting in its function as a trunk cover.

List of reference numbers

| | |
|---|---|
| 1 | Folding top compartment cover |
| 2 | Mount |
| 3 | Bracket |
| 4 | Link |
| 5 | Link |
| 6 | Frame |
| 7 | Main link |
| 8 | Auxiliary link |
| 9 | Joint |
| 10 | Joint |
| 11 | Joint |
| 12 | Joint |
| 13 | Bearing plate |
| 14 | Extension |
| 15 | Joint |
| 16 | Connecting rod |
| 17 | Joint |
| 18 | Arm |
| 19 | Pivot lever |
| 20 | Pivot axis |
| 21 | Second arm |
| 22 | Coupling point |
| 23 | Piston/cylinder unit |
| 24 | Bearing pin |
| 25 | Elongated hole guide |
| 26 | Supporting plate |
| 27 | Rotary latch |
| 28 | Axis |
| 29 | Control link |
| 30 | Joint |
| 31 | Joint |
| 32 | First lock unit |
| 33 | Front end |
| 34 | Bearing unit |
| 35 | Second lock unit |
| 36 | Lock hook |
| 37 | Transverse axis |
| 38 | Torsion spring |
| 39 | Stud |
| 40 | Actuating arm |
| 41 | Slotted guide |
| 42 | Actuating pin |
| 43 | Axis |
| 44 | Latching hook |
| 45 | Actuating arm |
| 46 | Elongated hole |
| 47 | Cable |
| 48 | Bowden |
| 49 | Latching stud |
| 50 | Housing |
| 51 | Piston rod |
| 52 | Centering lug |
| 53 | Centering receptacle |
| 54 | Gas-filled compression spring |

1. A locking mechanism for securing a support device of a folding top compartment cover of a convertible, which support device is movably mounted on a vehicle body by of a driving device,
comprising:
a first lock unit, which is mounted on the vehicle body, for releasably locking the support device to the vehicle body,
a second lock unit, which is mounted on the support device, for releasably locking the folding top compartment cover, which is movably mounted on the support device, to the support device, and
an actuating device for actuating the two lock units.

2. The locking mechanism as claimed in claim 1,
wherein the actuating device is connected to the driving device.

3. The locking mechanism as claimed in claim 1,
wherein the two lock units are arranged adjacent to each other.

4. The locking mechanism as claimed in claim 1, wherein when the second lock unit is actuated, the first lock unit is connected thereto in a releasable coupling engagement.

5. The locking mechanism as claimed in claim 1, wherein a latching hook of the first lock unit and a lock hook of the second lock unit can be coupled to each other via engagement elements.

6. The locking mechanism as claimed in claim 5,
wherein an actuating pin and a slotted guide which receives the actuating pin form the engagement element.

7. The locking mechanism as claimed claim 1, wherein in a closed position, the support device is kept locked to the vehicle body by the first lock unit, with the second lock unit having released the folding top compartment cover from the support device.

8. The locking mechanism as claimed in claim 1, wherein the actuating device, is connected to a latching hook of the first lock unit.

9. The locking mechanism as claimed in claim 1, wherein the second lock unit comprises a lock hook which is prestressed by a prestressing device into a closed position in which the lock nut keeps the folding top compartment cover or a bearing part of the folding top compartment cover locked to the support device.

10. The locking mechanism as claimed in claim 1, wherein the folding top compartment cover is attached by a mount to a bracket which is movably mounted on the support device by a link device.

11. The locking mechanism as claimed in claim 1, wherein the driving device is displaceably guided at an end thereof coupled to the actuating device along a guide and can be locked by a retaining device in an end position in which the first lock unit is unlocked.

12. The locking mechanism as claimed in claim 11, wherein the retaining device is actuatable by a lever, which is movable by the driving device, for driving the support device.

13. The locking mechanism as claimed in one of claim 1, wherein the support device is supported on the vehicle by a main link.

14. The locking mechanism as claimed in claim 1, wherein in the closed position, the support device is supported in a manner mounted on the vehicle by means of a centering receptacle.

15. The locking mechanism as claimed in claim 1, wherein the support device is a frame which is movably supported on the vehicle body via an articulated device, and the folding top compartment cover is pivotably mounted on said frame.

16. The locking mechanism as claimed in claim 1, wherein the driving unit is a linear adjustment unit.

17. The locking mechanism as claimed in claim 8, wherein the actuating device is a Bowden cable.

18. The locking mechanism as claimed in claim 13, wherein the main link is a form-bar linkage arrangement.

19. The locking mechanism as claimed in claim 15, wherein the articulated device is a multi-bar linkage mechanism.

20. The locking mechanism as claimed in claim 15, wherein the articulated device is a form-bar linkage mechanism.

21. The locking mechanism of claim 16, wherein the linear adjustment unit is a hydraulic piston/cylinder unit.
